(19) United States
(12) Patent Application Publication
(10) Pub. No.: US 2024/0087502 A1
(43) Pub. Date: Mar. 14, 2024

(54) SYSTEM FOR CONTROLLING THE BRIGHTNESS OF A DISPLAY

(71) Applicant: GlobalFoundries U.S. Inc., Malta, NY (US)

(72) Inventors: THORSTEN KAMMLER, Dresden (DE); RAN YAN, Dresden (DE); MICHAEL ZIER, Dresden (DE)

(21) Appl. No.: 17/931,135

(22) Filed: Sep. 12, 2022

(51) Int. Cl. G09G 3/32

(52) U.S. Cl. CPC G09G 3/32; G09G 2320/0626; G09G 2360/144

(57) ABSTRACT

The present disclosure generally relates to a system for use in optoelectronic/photonic applications and integrated circuit (IC) chips. More particularly, the present disclosure relates to a system including a driver circuit, a bias generator, and a light sensor. The driver circuit has at least one transistor including a back gate and a front gate. The bias generator is connected to the back gate of the transistor. The light sensor is connected to the bias generator. The system is capable of adjusting the brightness of a display unit to adapt to the brightness of an ambient light.

### FIELD OF THE INVENTION

The present disclosure generally relates to a system for controlling the brightness of a display. More particularly, the present disclosure relates to a system including a driver circuit, a bias generator, and a light sensor.

### BACKGROUND

Current developments within the Internet of Things and the field of communication have opened the door for various new applications and concepts. Examples of these new concepts are Augmented or Virtual Reality. Augmented Reality can be used to improve natural environmental situations, enriching the user's experience or supporting the user in performing certain tasks. Applications having augmented or virtual reality generally transport information to a user through visualization. For example, a user may use a display with augmented reality features to assist him in performing certain tasks. Haptic or other sensory perceptions can also be used to expand reality.

Electronic devices often include displays. Examples of electronic devices may include smartphones, tablet information terminals, eyewear devices, and notebook personal computers (PC). The displays on the electronic devices may have pixels with light-emitting diodes. With technologies that enable improved portability and better connectivity, these electronic devices have been used in environments with different ambient light brightness or luminance. It can be challenging to control or calibrate the brightness of the displays to adapt to the changing ambient light brightness due to the complexity of the control mechanism.

### SUMMARY

In an aspect of the present disclosure, there is provided a system including a driver circuit comprising at least one transistor, the transistor having a front gate and a back gate, a bias generator connected to the back gate of the transistor, and a light sensor connected to the bias generator.

In another aspect of the present disclosure, there is provided a system including a driver circuit comprising an array of transistors, each transistor having a front gate and a back gate, a bias generator connected to the back gate of each transistor in the array of transistors, a plurality of light sensors connected to the bias generator, a display unit connected to the driver circuit, a first semiconductor chip having the driver circuit and the bias generator, and a second semiconductor chip having the display unit.

### BRIEF DESCRIPTION OF THE DRAWINGS

The present disclosure may be understood by reference to the following description taken in conjunction with the accompanying drawings.

For simplicity and clarity of illustration, the drawings illustrate the general manner of construction, and certain descriptions and details of features and techniques may be omitted to avoid unnecessarily obscuring the discussion of the described embodiments of the present disclosure. Additionally, elements in the drawings are not necessarily drawn to scale. For example, the dimensions of some of the elements in the drawings may be exaggerated relative to other elements to help improve understanding of embodiments of the present disclosure. The same reference numerals in different drawings denote the same elements, while similar reference numerals may, but do not necessarily, denote similar elements.

FIG. 1 is a block diagram representing an example of a system having a driver circuit, a bias generator, and a light sensor.

FIG. 2 is a block diagram representing another example of a system in which the light sensor is integrated on a different semiconductor chip from the driver circuit and the bias generator.

FIG. 3 is a block diagram representing yet another example of a system in which the light sensor is integrated on a same semiconductor chip as the driver circuit and the bias generator.

### DETAILED DESCRIPTION

Various illustrative embodiments of the present disclosure are described below. The embodiments disclosed herein are exemplary and not intended to be exhaustive or limiting to the present disclosure.

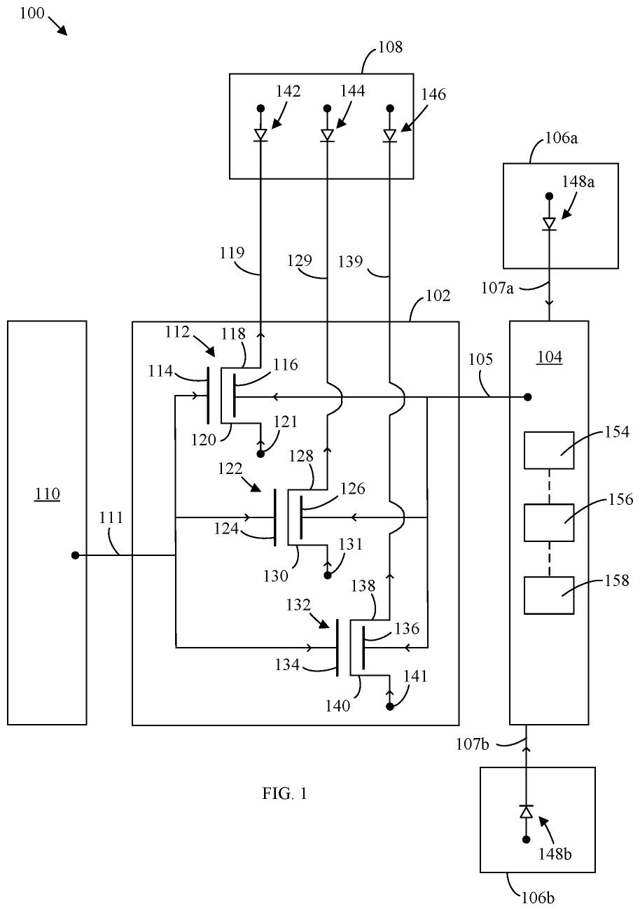

Referring to FIG. 1, a system 100 for use in controlling the brightness of a display may include a driver circuit 102, a bias generator 104, and at least one light sensor 106a, 106b. The bias generator 104 may be connected to the driver circuit 102 and the light sensor 106 may be connected to the bias generator 104. The system 100 may also include a display unit 108 connected to the driver circuit 102 and an image processing unit 110 connected to the driver circuit 102.

The driver circuit 102 may include at least one transistor or an array of transistors 112, 122, 132. Each transistor 112, 122, 132 may have a front gate (114, 124, 134, respectively), a back gate (116, 126, 136, respectively), a first terminal (118, 128, 138, respectively), and a second terminal (120, 130, 140, respectively). The first terminal 118, 128, 138 of each transistor 112, 122, 132 may be configured to provide an output signal 119, 129, 139 to the display unit 108. The second terminal 120, 130, 140 of each transistor 112, 122, 132 may be configured to receive an input signal 121, 131, 141. Current or electrical charges (e.g., electrons or holes) may flow between the first terminal 118, 128, 138 and the second terminal 120, 130, 140. The front gate 114, 124, 134 and the back gate 116, 126, 136 may be independently supplied with bias signals to control the current flow between the first terminal 118, 128, 138 and the second terminal 120, 130, 140.

Examples of transistors for the transistors 112, 122, 132 in the driver circuit 102 may include, but are not limited to, a field effect transistor (FET), a bipolar junction transistor (BJT), a complementary metal oxide semiconductor (CMOS) transistor, a metal oxide semiconductor field effect transistor (MOSFET), a planar FET, a fin-shaped FET, or a semiconductor on insulator (SOI) transistor. Preferably, the transistors 112, 122, 132 may be SOI transistors, in which the transistors 112, 122, 132 may each include a substrate, an insulator layer on the substrate, and a semiconductor layer on the insulator layer. A gate may be formed over the semiconductor layer and a gate dielectric layer may be formed between the gate and the semiconductor layer. The insulator layer may be vertically between the substrate and the semiconductor layer. The semiconductor layer may be partially depleted, or preferably fully depleted. In some implementations, the insulator layer may include a dielectric material (e.g., an oxide or a nitride) or include a semiconductor material (e.g., silicon or germanium) doped with a P-type dopant or an N-type dopant.

The front gates 114, 124, 134 of the transistors 112, 122, 132 may be connected to the image processing unit 110. The image processing unit 110 may be configured to provide a bias signal 111 to the front gates 114, 124, 134 of the transistors 112, 122, 132. The bias signal 111 may correspond to an image data from the image processing unit 110. The bias signal 111 from the image processing unit 110 may be a current or a voltage and may be provided in the form of a digital pulse signal or a square wave signal. The bias signal 111 may have at least two discrete levels and a pulse height. In an implementation, the image processing unit 110 may be programmed to generate the bias signal 111 using a pulse width modulation (PWM) method.

The back gates 116, 126, 136 of the transistors 112, 122, 132 may be connected to the bias generator 104. The bias generator 104 may be configured to provide a bias signal 105 to the back gates 116, 126, 136 of the transistors 112, 122, 132. The bias generator 104 may include one or more circuits, in which each circuit may include transistors, resistors, and other circuit components. Connecting the bias generator 104 to the back gates 116, 126, 136 of the transistors 112, 122, 132 may enable the bias signal 105 to modify or change the threshold voltage of the transistors 112, 122, 132. The bias signal 105 from the bias generator 104 may be a current or a voltage and may be provided in the form of a continuous analog signal or a sinusoidal wave signal. The bias signal 105 from the bias generator 104 may have a lower frequency than the bias signal 111 from the image processing unit 110. In some implementations, the back gate 116, 126, 136 of each transistor 112, 122, 132 may correspond to a body of each transistor 112, 122, 132. The body of each transistor 112, 122, 132 may refer to a substrate or a bulk substrate upon which each transistor 112, 122, 132 is formed. In implementations where the transistors 112, 122, 132 are the SOI transistors described herein, the bias signal 105 from the bias generator 104 may be applied to the substrate (i.e., the back gate) while the bias signal 111 from the image processing unit 110 may be applied to a gate structure (i.e., the front gate) formed over the semiconductor layer.

The light sensor 106a, 106b may include a diode 148a, 148b. The diode 148a, 148b may be a photodiode or a photodetector. Light may be incident on the light sensor 106a, 106b. The light sensor 106a, 106b may be configured to provide an electrical signal 107a, 107b to the bias generator 104 in response to the incident light. The electrical signal 107a, 107b may be an electrical current. The electrical current may have a strength that is proportional to an intensity of the incident light. For example, in environments where the incident light has a low intensity (i.e., a dimly lit environment), the electrical current generated by the light sensor 106a, 106b may be weak. In environments where the incident light has a high intensity (i.e., a brightly lit environment), the electrical current generated by the light sensor 106a, 106b may be strong.

The bias generator 104 may generate the bias signal 105 based on the electrical signal 107a, 107b from the light sensor 106a, 106b. The bias signal 105 may have an amplitude that varies adaptively to the changes in the strength or magnitude of the electrical signal 107a, 107b received by the bias generator 104. For example, if the electrical signal 107a, 107b is strong, then the generated bias signal 105 may have a waveform with a larger amplitude. Conversely, if the electrical signal 107a, 107b is weak, then the generated bias signal 105 may have a waveform with a smaller amplitude. In an implementation, the bias generator 104 may be programmed to generate the bias signal 105 using an adaptive biasing technique.

In some implementations, the bias generator 104 may include a monitoring component 154, a control component 156, and a generator component 158. The electrical signal 107a, 107b from the light sensor 106a, 106b may be transmitted to the monitoring component 154. The control component 156 may be in electrical communication with the monitoring component 154 and the generator component 158. The control component 156 may receive information from the monitoring component 154 relating to the intensity of light from the environment and then determine the strength or amplitude of the bias signal 105 to be generated by the generator component 158.

The bias signal 105 from the bias generator 104 may modulate the output signals 119, 129, 139 provided to the display unit 108. For example, the bias signal 111 from the image processing unit 110 may modulate the output signal 119, 129, 139 by controlling the current flow across the first terminal 118, 128, 138 and the second terminal 120, 130, 140 in the transistors 112, 122, 132 such that the output signal 119, 129, 139 may be a digital pulse signal having a pulse height. The variations in the amplitude of the bias signal 105 from the bias generator 104 may modulate the pulse height of the output signal 119, 129, 139. In environments with a higher intensity of incident light, the bias signal 105 may have a larger amplitude, and the output signal 119, 129, 139 may be modulated to have a larger pulse height. In environments with lower intensity of incident light, the bias signal 105 may have a lower amplitude, and the output signal 119, 129, 139 may be modulated to have a lower pulse height. The output signal 119, 129, 139 from the first terminal 118, 128, 138 of each transistor 112, 122, 132 may have a waveform combined from the waveform of the bias signal 105 from the bias generator 104 and the waveform of the bias signal 111 from the image processing unit 110.

The display unit 108 may include at least one diode or a plurality of diodes 142, 144, 146. Each diode 142, 144, 146 may be connected to the first terminal 118, 128, 138 of each transistor 112, 122, 132 in the driver circuit 102. Each of the first terminals 118, 128, 138 may provide the output signal 119, 129, 139 to the respective diodes 142, 144, 146. Although not shown in the accompanying drawings, in some implementations, each of the first terminals 118, 128, 138 may be connected to more than one diode in series. The diodes 142, 144, 146 in the display unit 108 may be configured to emit light such that an image may be displayed. The diodes 142, 144, 146 may be light emitting diodes (LEDs).

The brightness or the intensity of the light emitted by the diodes may correlate to the pulse height (or amplitude) of the output signals 119, 129, 139 received by the display unit 108. For example, if the output signals 119, 129, 139 are modulated to have higher pulse heights by the bias signal 105 from the bias generator 104, then the diodes 142, 144, 146 may generate a higher intensity light such that the displayed image becomes brighter in an environment with brighter ambient light. If the output signals 119, 129, 139 are modulated to have lower pulse heights by the bias signal 105 from the bias generator 104, then the diodes 142, 144, 146 may generate a lower intensity light such that the displayed image becomes dimmer in an environment with dimmer ambient light. The connection of the bias generator 104 to the back gates 116, 126, 136 of the transistors 112, 122, 132 in the driver circuit 102 may enable the brightness of the image displayed by the display unit 108 to adapt to the changes in the intensity of the incident light on the light sensor 106a, 106b.

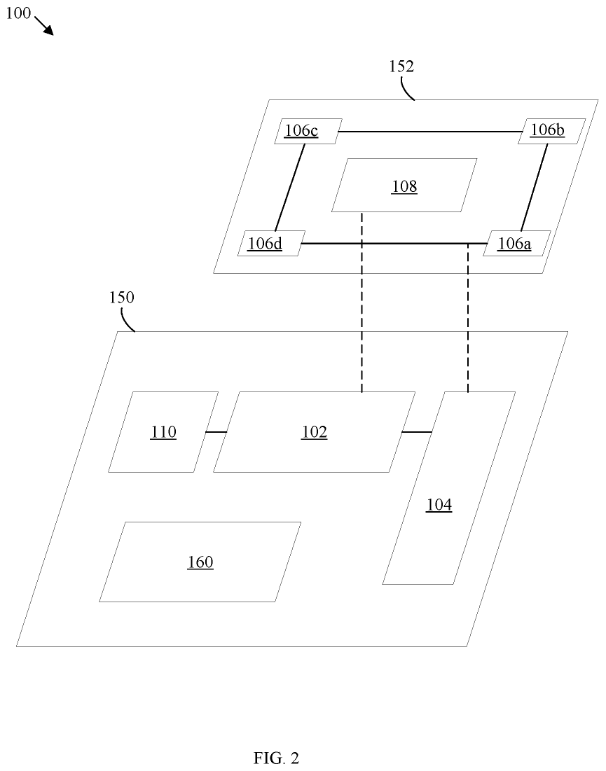

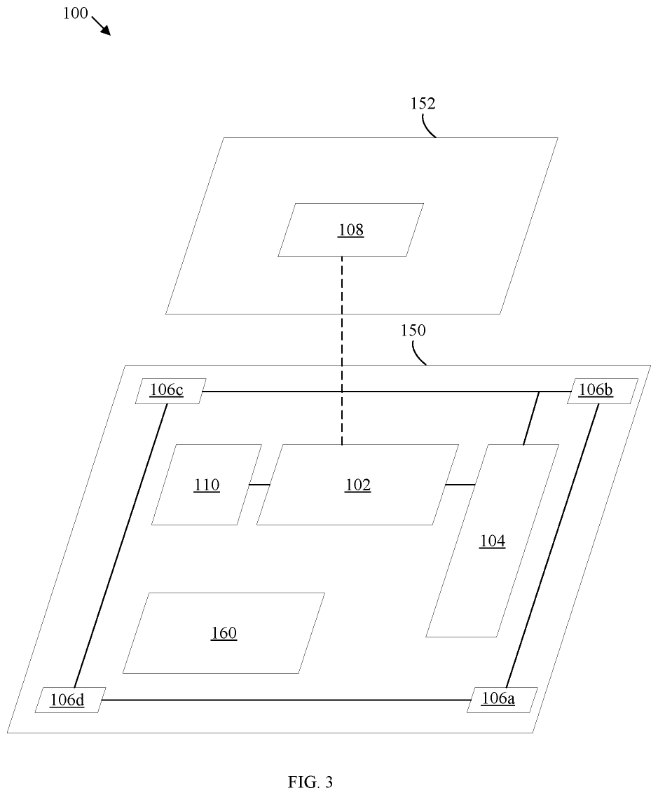

Referring to FIG. 2 and FIG. 3, the system 100 may include a first semiconductor chip 150 and a second semiconductor chip 152. The driver circuit 102 and the bias generator 104 may be integrated on the same semiconductor chip (i.e., the first semiconductor chip 150) while the display unit 108 may be integrated on a different semiconductor chip from the driver circuit 102 and the bias generator 104 (i.e., the second semiconductor chip 152). The first semiconductor chip 150 may also have the image processing unit 110 as well as other circuitry components, such as a memory component 160. The memory component 160 may include, but is not limited to, static random access memory (SRAM) circuits, magnetic random access memory (MRAM) circuits, resistive random access memory (RRAM) circuits, or dynamic random access memory (DRAM) circuits. In some implementations, the memory component 160 may function as a storage of pulse width modulation information for the generation of the bias signal provided to the front gates of the transistors in the driver circuit 102. Examples of other circuitry components on the first semiconductor chip 150 may include, but are not limited to, processors, or wireless connectivity modules. The first semiconductor chip 150 and the second semiconductor chip 152 may be packaged or assembled together, for example, using flip chip bonding. Various interconnect features (e.g., interconnect vias and conductive lines) may be used to connect the driver circuit 102 with the display unit 108.

In the example shown in FIG. 2, the light sensors 106a, 106b, 106c, 106d may be integrated on the same semiconductor chip as the display unit 108 (i.e., the second semiconductor chip 152). The light sensors 106a, 106b, 106c, 106d may be preferably arranged to surround the display unit 108. The light sensors 106a, 106b, 106c, 106d may also be preferably arranged proximal to the edges of the second semiconductor chip 152. In the example shown in FIG. 3, the light sensors 106a, 106b, 106c, 106d may be integrated on the same semiconductor chip as the driver circuit 102 and the bias generator 104 (i.e., the first semiconductor chip 150). The light sensors 106a, 106b, 106c, 106d may be preferably arranged to surround at least the driver circuit 102, the bias generator 104, and the display unit 108. Additionally, the light sensors 106a, 106b, 106c, 106d may be preferably arranged proximal to the edges of the first semiconductor chip 150.

Throughout this disclosure, the terms “comprise”, “include”, “have”, and any variations thereof, are intended to cover a non-exclusive inclusion, such that a process, method, article, or device that comprises a list of elements is not necessarily limited to those elements, but may include other elements not expressly listed or inherent to such process, method, article, or device. Occurrences of the phrase “in an embodiment”, “in an example”, “in an implementation” herein do not necessarily all refer to the same embodiment, example, or implementation, respectively.

The descriptions of the various embodiments of the present disclosure have been presented for purposes of illustration, but are not intended to be exhaustive or limited to the embodiments disclosed. Modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Furthermore, there is no intention to be bound by any theory presented in the preceding background or the following detailed description. Additionally, the various tasks and processes described herein may be incorporated into a more comprehensive procedure or process having additional functionality not described in detail herein.

References herein to terms modified by language of approximation, such as “about”, “approximately”, and “substantially”, are not to be limited to the precise value specified. The language of approximation may correspond to the precision of an instrument used to measure the value and, unless otherwise dependent on the precision of the instrument, may indicate +/−10% of the stated value(s).

As will be readily apparent to those skilled in the art upon a complete reading of the present application, the system disclosed herein may be employed in a variety of different electronic products, including, but not limited to, electronic eyewear, augmented reality glasses, laptops, mobile phones, display monitors, etc.

What is claimed is:

1. A system comprising:
a driver circuit comprising at least one transistor, the transistor having a front gate and a back gate;
a bias generator connected to the back gate of the transistor; and
a light sensor connected to the bias generator.

2. The system of claim 1, further comprising a display unit connected to the driver circuit.

3. The system of claim 2, wherein the transistor includes a first terminal configured to provide an output signal to the display unit, and a second terminal configured to receive an input signal.

4. The system of claim 3, wherein the front gate of the transistor and the back gate of the transistor are independently supplied with bias signals to control a current flow between the first terminal and the second terminal.

5. The system of claim 3, wherein the display unit includes at least one diode connected to the first terminal of the transistor.

6. The system of claim 3, wherein the light sensor is configured to provide an electrical signal to the bias generator in response to an incident light on the light sensor.

7. The system of claim 6, wherein the light sensor includes a photodiode.

8. The system of claim 6, wherein the bias generator is configured to provide a bias signal to the back gate of the transistor.

9. The system of claim 8, wherein the bias signal is generated based on the electrical signal from the light sensor.

10. The system of claim 9, wherein the bias signal from the bias generator modulates the output signal provided to the display unit.

11. The system of claim 10, further comprising an image processing unit connected to the driver circuit.

12. The system of claim 11, wherein the image processing unit is configured to provide a bias signal to the front gate of the transistor, the bias signal corresponds to an image data from the image processing unit.

13. The system of claim 10, wherein the transistor in the driver circuit comprises:
a substrate;
an insulator layer on the substrate; and
a semiconductor layer on the insulator layer, the semiconductor layer is fully depleted, and the insulator layer is vertically between the substrate and the semiconductor layer, wherein the bias signal from the bias generator is applied to the substrate.

14. The system of claim 2, further comprising a first semiconductor chip, wherein the driver circuit and the bias generator are integrated on the first semiconductor chip.

15. The system of claim 14, further comprising a second semiconductor chip, wherein the display unit and the light sensor are integrated on the second semiconductor chip.

16. The system of claim 14, further comprising a second semiconductor chip, wherein the display unit is integrated on the second semiconductor chip and the light sensor is integrated on the first semiconductor chip.

17. A system comprising:
a driver circuit comprising an array of transistors, each transistor having a front gate and a back gate;
a bias generator connected to the back gate of each transistor in the array of transistors;
a plurality of light sensors connected to the bias generator;
a display unit connected to the driver circuit;
a first semiconductor chip having the driver circuit and the bias generator; and
a second semiconductor chip having the display unit.

18. The system of claim 17, wherein the plurality of light sensors is integrated on the first semiconductor chip or the second semiconductor chip.

19. The system of claim 17, wherein each transistor in the array of transistors includes a first terminal configured to provide an output signal to the display unit.

20. The system of claim 19, wherein the display unit includes a plurality of diodes, each diode is connected to the first terminal of each transistor in the array of transistors.
